(19) United States
(12) Patent Application Publication
(10) Pub. No.: US 2003/0190204 A1
(43) Pub. Date: Oct. 9, 2003

(54) Internal machining tool and system to self-clean and self-lubricate the tool and part being formed, while performing internal turning boring, grooving finishing machining operations

(76) Inventor: John Scott Wiseman, Brightwood, OR (US)

Correspondence Address: JOHN S. WISEMAN, P.O. BOX 193, BRIGHTWOOD, OR, 97011, US

(21) Appl. No.: 10/116,917

(22) Filed: Apr. 8, 2002

(51) Int. Cl. B23Q 11/10

(52) U.S. Cl. 409/136

(57) ABSTRACT

A machining tool cutter for primary use in the industry of ferrous and non ferrous metals machining or the like. The much improved machining tool cutter along with a compressed air supply, a machining lubricant distribution apparatus, an on/off control valve, and other pneumatically related components, creates a system which ejects a hi velocity jetstream of air or air and machining lubricant mist to flow from a nozzeled exit hole on the machining tool cutter to clean away it's own part forming debris by propelling them away from the machining tool cutter and simultainiously utilizing the machining lubricant mist to lubricate the cutting edges of the machining tool cutter while it performs it's part forming operations such as internal boring, grooving, chamfering, etc. etc . . .

### REFERENCES CITED

U.S. Patent Documents

U.S. Pat. No. 5,086,878

### FIELD OF THE INVENTION

This invention relates to the industry of manufacturing where the machining or part forming of ferrous and non-ferrous metals, plastics and in some instances wood, requires a tool that machines or forms the inside of a workpiece or part by, entering an orifice or hole and forming the workpiece to the desired shapes and dimensions.

There are numerous problems associated with all other internal machining tools. However, the most unsolved problem has been the capability to dis-allow the part forming or, the machining debris to entangle themselves inside of the workpiece and around the machining tool. When the machine operator allows this to happen, it causes disruptions in the part forming tool's functions by obstructing and limiting the movements of the said machining tool. These part forming debris pack themselves inside of the said part and force pressure in multiple directions on the machining tool. This pushing and pulling on the said tool while it attemps to perform it's part forming operations creates dimensional and physical machined surface flaws known as, “out of tolerance” or “non conforming” areas. This results in unusable workpieces and, forces the machine operator to constantly attempt to remove the machining shavings from the orifice of the said part. Not only is this attempt very time consuming for the operator, it is also dangerous to this person when having to remove their hands from the controls of the machine and expose them to mechanical movements such as a rotating spindle and workpiece in which the operator no longer has control of.

The machine operator is also at risk of injury when the said cutter shavings apply so much unwanted pressure to the part forming tool that it ends up breaking or shattering dangerously towards the operator.

Where my invention differs from all other prior art is as seen in FIG. 2, where the machining tool 1 has entered the drilled orifice and formed the inside of the part 14 while discharging a hi velocity jetstream of air and machining lubricant mist 25 into the orifice of the workpiece from the nozzled exit hole 5 in the machining tool 1 thus ejecting the machining debris 15 from the inside of the workpiece 14 and eliminating their entanglement around the said tool 1. Thus resulting in no obstructions or disruptions to the machining tool 1, while it performs it's machining oprations. This ultimately provides a much safer and less time consuming machining environment for the machine operator as well as a correctly machined workpiece.

### SUMMARY OF THE INVENTION

The present invention provides a system to internally machine or form a part made from a ferrous or non ferrous metal, plastic, or wood, by utilizing a machining tool that economically and, effectively increases the dimensional accuracy and physical nature of the workpiece being machined and, at the same moment, provides a much safer machining environment for the machine operator by, discharging a hi velocity jetstream mist of air and machining lubricant into the pre-drilled orifice of the part being formed. Thus ejecting the machining debris from the cavity being machined. And ultimately, eliminating the entanglement of the machining shavings inside of the said workpiece being formed as well as around the said machining tool. While simultaneously lubricating the said tool to reduce friction and increase it's wear life.

### BRIEF DESCRIPTION OF THE DRAWINGS

These and other objects and aspects of the invention will become apparent in the detailed description of the invention hereinafter with respect to the drawings in which:

(FIG. 1) Shows all machines and components connected in series to implement a system for a self-cleaning and self-lubricating internal machining tool.

(FIG. 2) Is a view of the self-cleaning and self-lubricating internal machining tool 1, performing it's machining operations while the hi velocity jetstream of air and machining lubricant mist ejects the part forming debris 15, from the inside of the workpiece being machined 14, and lubricates the tool 1, with machining lubricant 23.

(FIG. 3) Is a top view and a front view of the invention machining tool 1.

(FIG. 4) Shows the air compressor with the compressed air supply reservoir/tank 13.

(FIG. 5) Shows the oil distribution apparatus. (Known in the field as the “in line oiler”) This component distributes the machining lubricant into the flow of compressed air.

(FIG. 6) Shows the on/off valve which controls the flow of the hi velocity jetstream of air and machining lubricant mist. This valve can be operated either manually or electronically.

(FIG. 7) Is a fully dimensioned drawing showing exactly how to make the invention/machining tool.

**NOTE: Although FIG. 7 shows many of the invention/machining tool's functioning characteristics, FIG. 7 has none of the numerical references as shown in FIGS. 1 Thru 6.

FIG. 7's numerical references reflect the detailed information within the flag notes on FIG. 7 which are required to properly manufacture the invention/machining tool.

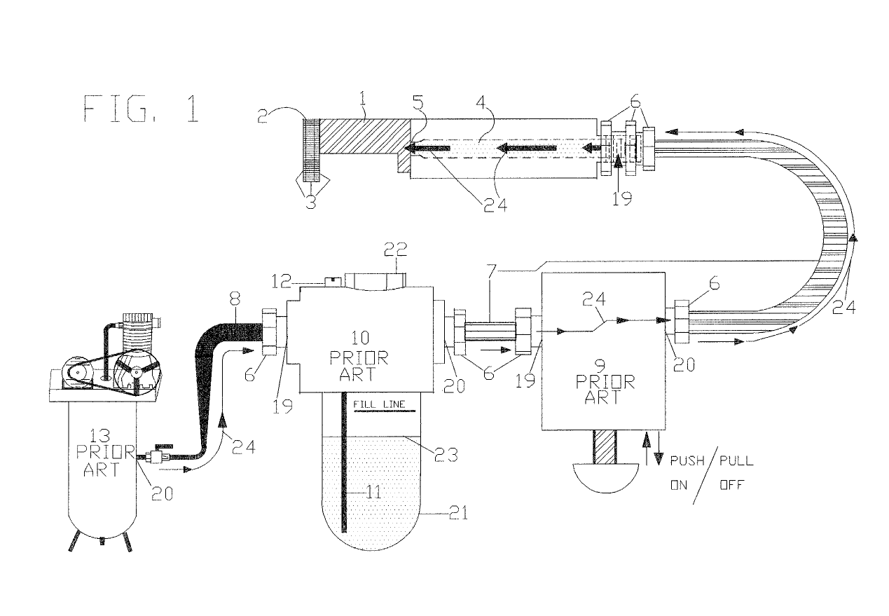

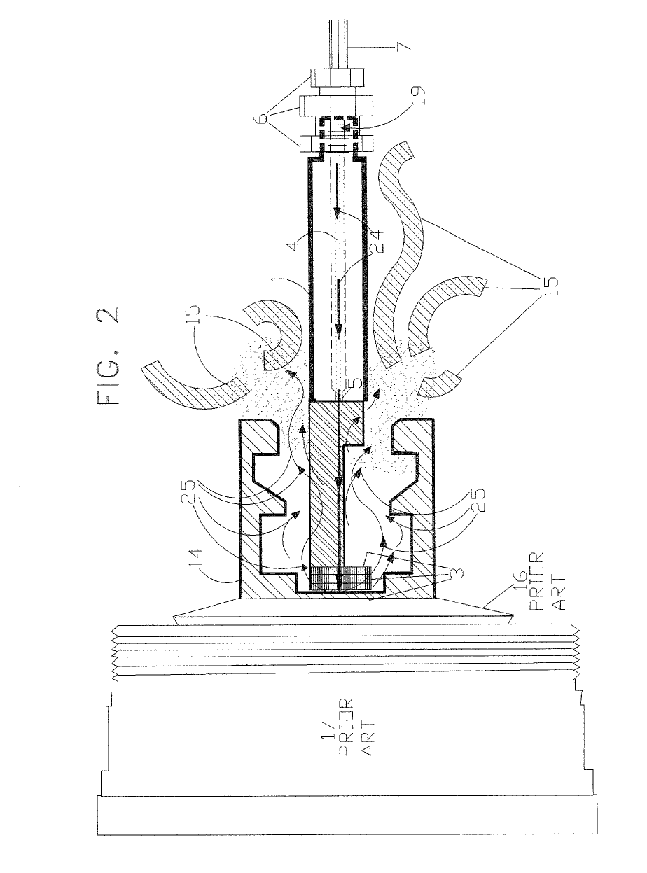

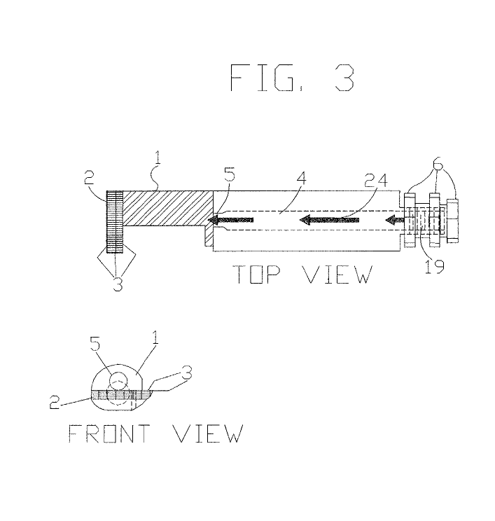

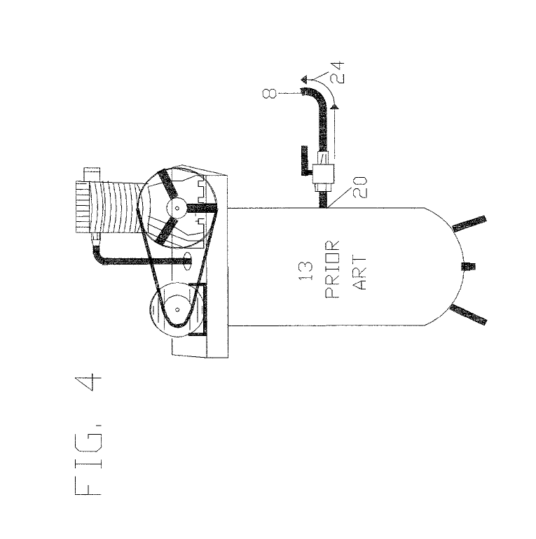

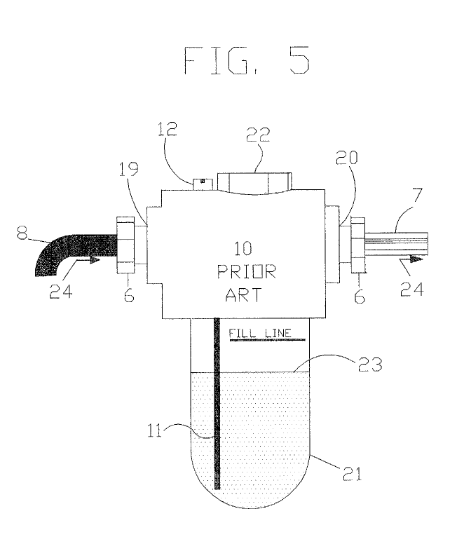

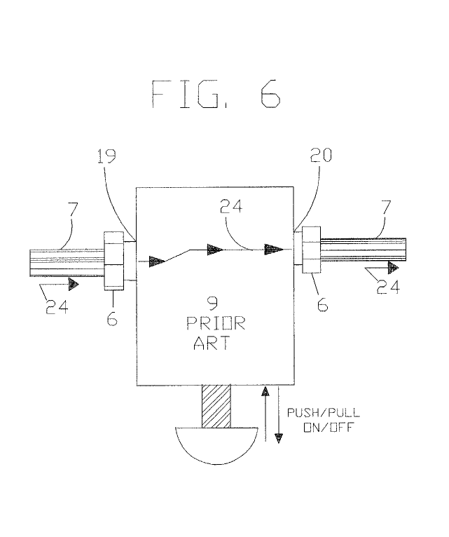

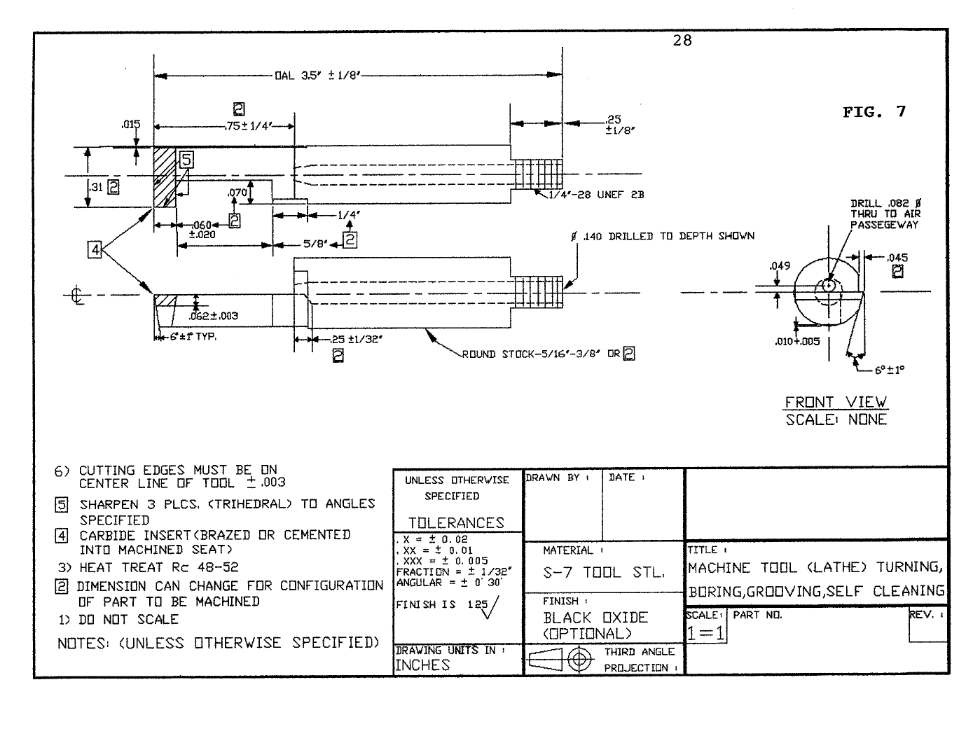

### DETAILED DESCRIPTION OF THE INVENTION

With reference to FIGS. 1 thru 6, the present invention is a system which incorporates several important pneumatic components and equipment to create a machining tool cutter invention that cleans away it's own part forming debris while simultaniously, lubricating it's own cutting edges as shown in FIG. 1.

The compressed air supply tank 13 delivers hi pressure air flow to the machining lubricant distribution apparatus 10, utilizing an air hose of suitable means 8 and threaded couplings 6 to fay the outlet port 20 on the compressed air supply tank 13 to the inlet port 19 on the machining lubricant distribution apparatus 10, creating the direction of hi pressure air flow 24.

As the hi pressure air flow 24 enters the machining lubricant distribution apparatus 10, it creates a ventury siphon effect by drawing a fluid 23 (preferably a machining lubricant) from it's reservoir 21, thru a siphon pick-up tube 11 and dispensing the machining lubricant into the hi pressure air flow thus creating an air and machining lubricant mist. The hi pressure mist is then discharged thru the ventury being connected to the outlet port 20 of the machining lubricant distribution apparatus 10, while, controlling the amount of machining lubricant being discharged into the hi pressure air flow is accomplished by turning the fluid siphon adjustment screw 12. The fluid fill cap 22 being at the top of the machining lubricant distribution apparatus 10 as well.

From the outlet port 20 on the machining lubricant distribution apparatus 10, the hi pressure mist flow 24 enters the inlet port 19 on the hi pressure pneumatic on/off valve 9 via the hi pressure pneumatic hose/line 7 which is also fayed to the outlet port 20 on the machining lubricant distribution apparatus 10, utilizing the threaded couplings 6 to secure the two end connections to each of the said components as shown in FIG. 1.

When the said valve 9 is manually or electronically moved to the on position, the hi pressure air and machining lubricant mist flow 24 exits the outlet port 20 on the said valve 9, and is discharged thru the hi pressure pneumatic hose/line 7, and enters into the inlet port 19 on the machining tool cutter invention 1. And again utilizing threaded couplings 6 to secure the inlet port 19 and outlet port 20 connections as shown in FIG. 1.

From the inlet port 19 on the machining tool cutter invention 1, the hi pressure mist flows thru the air and machining lubricant mist passageway 4, which is located inside the shank body of the said machining tool cutter invention 1.(As shown in FIGS. 1,2 and 7) The said mist is then propelled thru a nozzelled exit hole 5, thus creating a hi velocity jetstream of air and machining lubricant mist, which is dispensed into the drilled orifice of the workpiece being machined 14, as shown in FIG. 2.

The workpiece being machined 14 (being tightly secured to a lathe spindle 17 with a workpiece clamping collet 16) is spun (or rotated) on either a horizontal or vertical plane. As the machining tool cutter invention 1 enters the drilled orifice of the spinning workpiece to be machined 14, the hi velocity jetstream of air and machining lubricant mist being discharged from the nozzeled exit hole 5 ejects and cleans away the machining shavings 15 from the bore of the workpiece being machined 14 and, lubricates the cutting edges 3 on the machining tool cutter invention 1 while the said tool performs it's boring, grooving and chamfering part forming operations.

The summation being the completion of a system which allows the machining tool cutter invention 1 to clean away it's part forming debris 15 and simultaniously lubricate it's cutting edges 3 to reduce friction and wear. While the said tool 1 performs it's boring, grooving, turning and chamfering part forming operations as shown functioning in FIG. 2.

What I claim as my invention is:

1. A machining tool cutter of the type comprising a nozzle exit hole wherein said nozzle exit hole is fayed to a through-hole to create a passageway to discharge a hi-velocity jetstream flow of compressed air or a combination of machining lubricant and compressed air from said nozzle exit hole.

2. The machining tool cutter of claim 1 wherein said tool is one component incorporated in an organized system wherein said organized system utilizes machinery, pneumatic equipment, pneumatic apparatuses, and components to produce and to control said flow and said discharge of said hi-velocity jetstream of said compressed air or a combination of machining lubricant and compressed air from said nozzle exit hole.
